(19) United States
(12) Patent Application Publication
(10) Pub. No.: US 2007/0033763 A1
(43) Pub. Date: Feb. 15, 2007

(54) Cable swiper

(76) Inventor: Klaus Manfred Steinich, Zorneding (DE)

Correspondence Address: HEAD, JOHNSON & KACHIGIAN, 228 W 17TH PLACE, TULSA, OK, 74119, US

(21) Appl. No.: 11/500,920

(22) Filed: Aug. 8, 2006

(30) Foreign Application Priority Data
Aug. 9, 2005 (DE) 102005037626.6

(51) Int. Cl. B08B 1/00

(52) U.S. Cl. 15/256.6; 15/88

(57) ABSTRACT

A cable swiper, in particular usable with distance measuring cable sensor, for cleaning a cable passing through in a linear manner, with at least one swiper brush, whose bristles touch the external circumference of the cable, and which are each held with their other ends and in a particularly C-shaped bristle holder, a holding device for fixating the at least one swiper brush to another component associated with the cable, in particular a cable outlet bushing, wherein the ends of the at least one swiper brush are received.

### CROSS REFERENCE TO RELATED APPLICATIONS

This application claims priority to German Patent Application No. 102005037626.6 filed 9 Aug. 2005.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### REFERENCE TO A MICROFICHE APPENDIX

Not Applicable

### BACKGROUND OF THE INVENTION

1. Field of the Invention

The invention regards cable swipers. A cable swiper is used wherever a rope or an element similar to a rope like a lead, a wire, a cable or something similar is to be cleaned from solid contaminants at its outer circumference. For this purpose, a cable swiper is located around the outer diameter of the cable and moved in a longitudinal direction relative to the cable.

Typical applications are so-called cable pull distance measuring sensors, wherein the measuring cable, pulled off from a cable drum, preloaded by a winding device, represents the distance from the end of the measuring cable to the cable drum. Such measuring cable sensors generally are safety relevant parts and have to have a very high useful life of 1 million and more extensions. Thereby, the degree of possible contamination in the interior of the housing plays a substantial role. The housing is mostly sealed; however, contaminants adhering to the outer surface of the cable are transported into the interior through the cable intake channel and can form deposits there, negatively affecting the function.

Therefore, in such cable distance measuring sensors—as well as in many other applications with a moving cable—a cable swiper is located at the cable intake, or at another appropriate location, which is supposed to remove the contaminant particles adhering to the cable.

Cable swipers with rubber tips are also known, as well as cable swipers with mostly annular brushes with bristles, or lips pointed towards the cable.

On the one hand at some point in time, the bristles wear out, with the consequence that they do not touch the cable any more with their free ends. On the other hand, these brushes themselves have to be cleaned or exchanged from time to time to remove contaminants accumulated thereupon over the course of time.

Other cable swipers, especially brush swipers, in connection with a wetting of the cable with grease or other paste substances have proven to be rather counter-productive for long-term functionality.

### BRIEF SUMMARY OF THE INVENTION

It is an object of the invention to provide a cable swiper, in particular useable with distance measuring cable sensors, that is constructed in a simple and cost effective manner, easy to disassemble and exchange, and still reliable and functional during the long term.

Since the one or several swiper brushes are located at one of two separate holders with their ends, they can be easily separated from those through removing, either in axial or in radial direction, and thereby can be replaced without having to replace the holders themselves. The cable can remain continuous and does not have to be removed from its end mounts.

Through the extension of the one or several swiper brushes over the total actual swiping length, the swiper brushes themselves can be an element determining the stiffness of the whole swiper through their internal stability, so that only at their axial ends, housing devices, in particular for mounting at an adjacent component, are required, not however a housing covering the whole swiper in an axial direction.

The holding devices herein can comprise annular, or annular slotted, thereby C-shaped holders, where the ends of the one or several swiper brushes adhere or are located.

The area between the ends of the swiper brush therefore is easily accessible for cleaning the brush or controlling its function at the cable, in particular the sufficient adherence to the cable.

A slotted ring, this means a C-shape, does not only facilitate the mounting on the cable through inserting the cable through the slot but also facilitates a slight radial compression when the material of the C-shaped holder is sufficiently elastic.

As a compressing piece e.g. a simple hose clamp can serve, which serves on the holder, facing the adjacent component, e.g. the cable inlet spout of the housing, to simultaneously connect the cable sweeper with the cable intake spout, with the holder adjacent to the inlet spout having approximately the same exterior diameter as the inlet spout and the hose clamp covering both parts in an axial direction.

Also folding at least a partial axial area of this holder over the inlet spout and clamping it with a hose clamp, or also with a clamping bolt, is possible.

A particularly simple design evolves with two special brush shapes.

When using a helical spiral brush with bristles pointing inward towards the longitudinal axis of the helix, a single such spiral brush, whose length can be determined depending on the desired cleaning effect, and which can be provided with different bristle materials along its extension, is sufficient

With its end facing the inlet spout, the external radial bristle holder can be located in the interior circumference of an adapter, which is radially compressed with a hose clamp on its outside and which in turn is held on the cable inlet spout.

On the other end only one holder is required, reducing the free pass through compared to the free space inside the helical bristle holder, e.g. in the form of a stop plate in order to have the bulge at the end of the cable stop against it.

Preferably, the single windings of the helical bristle holder thereby are so far apart that the diameter of the cable can be placed in between, thus, the spiral brush can be threaded onto the continuous cable and through inserting the cable at one end of the helix between the windings and continuing to thread until the cable is completely located in the interior of the helix.

This procedure is also possible when the windings of the spiral brush are spaced apart less, but can be pulled apart or pressed apart in order to insert the cable in between.

Another embodiment results from using one or several longitudinal brushes distributed over the circumference, primarily running in the direction of the cable and the cable swiper.

Thereby linear longitudinal brushes can be employed, with an orientation in parallel to the moving direction of the cable. Several such linear brushes are located around the circumstance, so that the bristle holder is on the outside in a radial direction, with the bristles protruding therefrom radially towards the interior and against the cable, touching it with their free ends. In this manner four linear longitudinal brushes are used, spaced by 90° each.

The stable bristle holder, mostly a U-profile, also extending in longitudinal direction can thereby be inserted with its ends in radial or axial direction, into respective receiving slots, wherefrom the bristles of the brush can protrude into the cavity radially inward. When these receiving slots reach through the annular, C-shaped, at least radially deformable holder, completely in a radial direction, they have a radial taper towards the inside, in order to prevent pushing the bristle holders, which also are preferably conical in this direction, too far forward.

Such a holder is radially enclosed on the outside by a bushing, ideally a simple hose clamp, simultaneously holding the ends of the longitudinal brushes in its receiving slots.

The holder can either be made flexible in the radial direction, or in particular enable a simple radial insertion onto the cable, e.g. being a slotted ring, thus, having a C-shape. The receiving slots can hereby only be present in an axial end area. Instead of linear longitudinal brushes, slightly helical longitudinal brushes following the imaginary enveloping surface of the cable swiper can be used in order to reliably and evenly clean all circumferential areas of the cable. Preferably, the twist will be so small that a longitudinal brush turns by less than one full revolution around the cable, preferably only by one angular segment of 360°, divided by the number of longitudinal brushes distributed over the circumference.

The problem of a cable not coming out of the cable outlet bushing exactly in the middle is solved through providing the approximately annular or C-shaped holder and the surrounding additional ring or C-piece in a double eccentrical manner.

The longitudinal brushes are mounted in the interior holder; the bristles of the particular brushes protrude towards the inside to a different extent and do not meet in the middle of the circular outside contour of the interior holder, but in an off set manner at a point, which is the middle of the circular circumference of the external holder.

Through rotating the two eccentrical pieces, i.e. the interior and exterior holder relative to each other, the center, toward which the longitudinal brushes are working, can be adjusted within the adjustment range determined by the eccentricities, so that the bristles reliably run on the exterior surface of the cable.

Another possibility comprises locating the longitudinal brushes directly in the interior sides of a bore, eccentric relative to the exterior circumference of a single, preferably slotted and in particular externally circular holder, since hereby the number of components is reduced and the same effect can be achieved.

### BRIEF DESCRIPTION OF THE SEVERAL VIEWS OF THE DRAWINGS

Embodiments of the invention are subsequently described in more detail, wherein the figures show the following:

FIGS. 1a-d show a solution with a spiral brush.

FIGS. 2a-c illustrate a solution with four longitudinal brushes distributed over the circumference.

FIGS. 3a-c are detailed illustrations of the holder of the present invention.

FIGS. 4a-b are detailed illustrations of the longitudinal brush of the present invention.

### DETAILED DESCRIPTION OF THE INVENTION

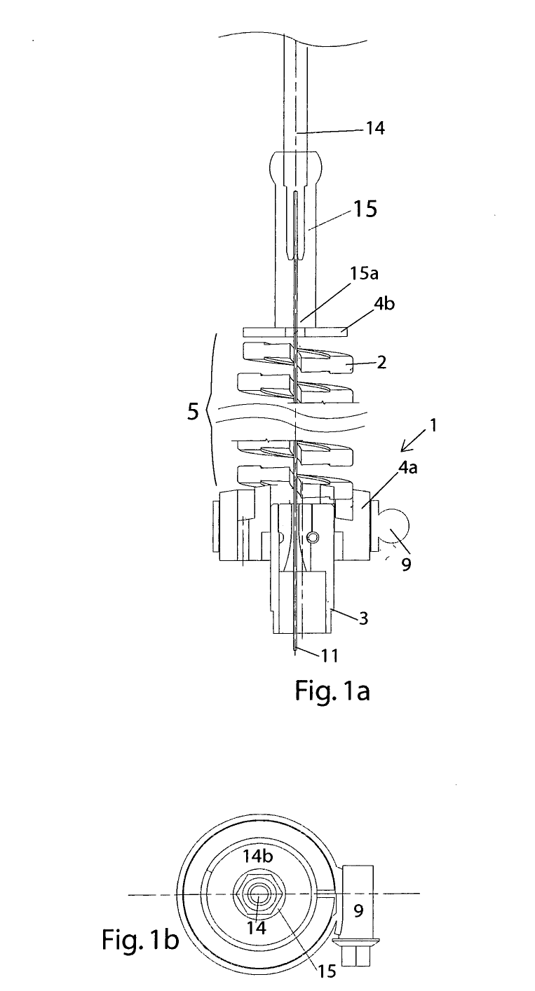

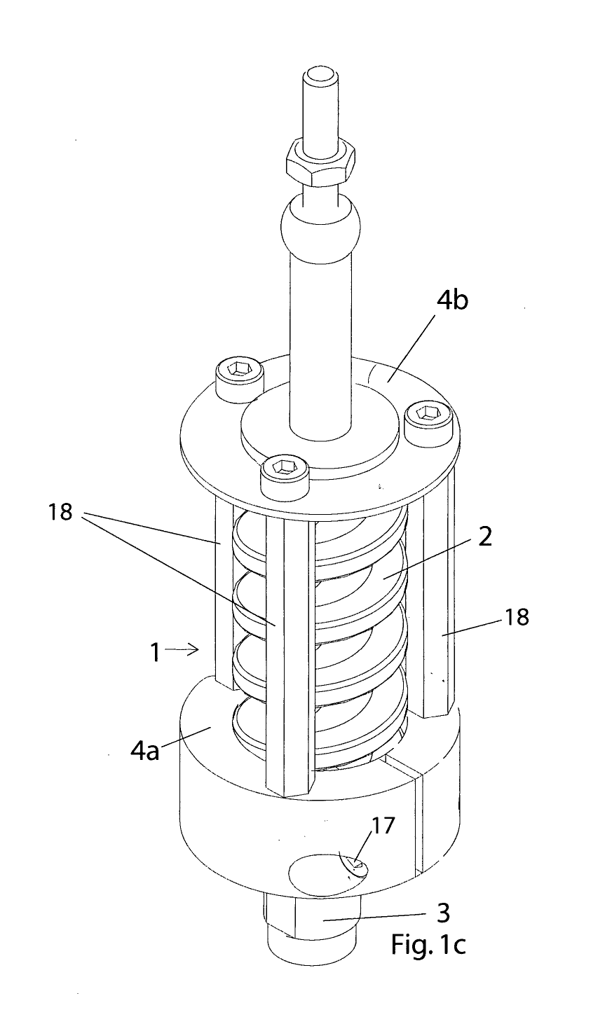

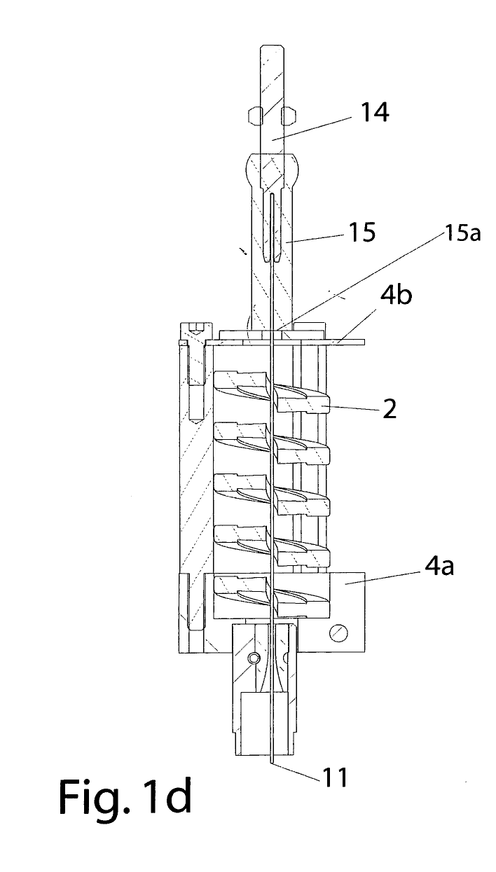

FIG. 1 shows a longitudinal cut view of a fully assembled cable swiper 1 mounted onto a cable inlet bushing 3 of an apparatus, in particular a distance measuring cable sensor, not shown.

At the free end of a cable 11, a fixation element 14 is mounted that is held on cable 11 by a thickened fixation piece 15 that partially covers cable 11 as well as fixation element 14 in a longitudinal direction.

Fixation piece 15 has a diameter that is much larger than the diameter of cable 11 and a stop surface 15a pointing towards inlet bushing 3.

Cable 11 leaves a housing, not shown, through cable inlet bushing 3, on whose exterior diameter the C-shaped lower holder 4a is located with its respective interior diameter. In the axial end of the holder, pointed away from the cable spout, an interior circumference is provided, wherein a helix-shaped spiral brush 2 is inserted with its exterior diameter.

A hose clamp, run around the round external circumference of holder 4a and tightened, presses the respective interior circumferences of the slotted C-shaped holder 4a in FIGS. 1a and 1b, and on one hand against the exterior circumference of the cable inlet bushing 3, and on the other hand against the exterior circumference of the spiral brush 2, both of which hose clamp 9 preferably covers in an axial direction, fixating spiral brush 2 to cable inlet spout 3.

At the opposite end, in FIGS. 1a and FIG. 1b, a holder 4b is placed onto the frontal end of spiral brush 2, preferably shaped as a slotted plate, whose slot is wide enough to be able to insert cable 11 in a radial manner into the central cavity in the middle of the holder 4b. The front face of holder 4b, pointing towards spiral brush 2, can have steps according to the conical shape of the end of the helical spiral brush.

FIGS. 1c and 1d differ from the solution in FIGS. 1a and 1b in some details:
On the one hand, the lower holder 4a is not compressed by a hose clamp but through a clamping bolt 17, clamping the opposing ends of the C-shaped holder 4a against each other over the slot.
The upper holder 4b is not slotted but an enclosed ring which can be threaded over the mounting element 14 from above and thereby over the end of the cable from the top.
On one hand, there is a longitudinal connection, besides the helical brush itself, between the upper and the lower holder 4a, b, wherein studs 18 are treaded between the two holders outside of the brush.

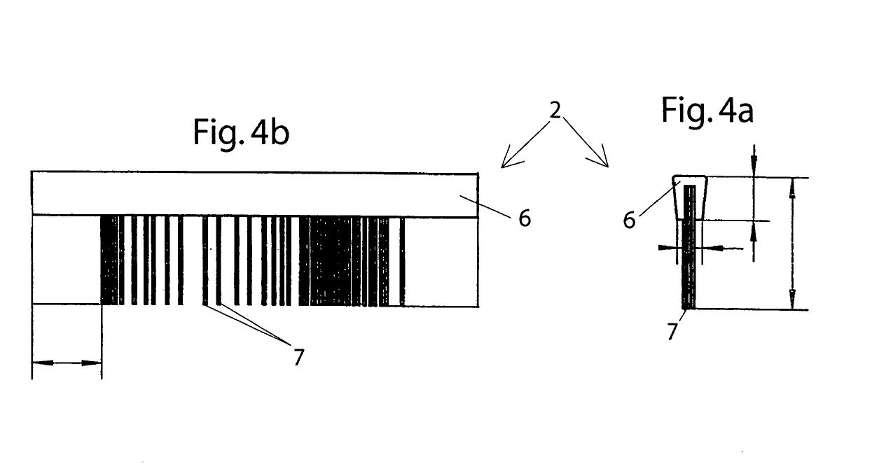

Spiral brush 2 itself is shaped as a one-turn helix, wherein FIG. 4a shows a cross section through a winding of spiral brush 2.

From a bristle holder 6, formed as a U-shaped body, e.g. a sheet metal profile or a plastic profile, bristles 7 protrude from the narrow side of the profile, radially towards the inside with reference to the longitudinal middle of the helix where cable 11 is located.

Spiral brush 2 is sufficiently flexible to be able to, with the cable pulled out by a certain amount, i.e. with the fixation piece 15 removed from the cable swiper 1, thread the cable in its middle area between the first two windings of the spiral brush 2 and keep threading until the cable 11 is in the longitudinal middle of the helical spiral brush 2.

Since holders 4a, b and hose clamp 9 also open radially, they can be radially pushed onto the cable, and the complete cable swiper can be mounted to and from the continuous cable 11.

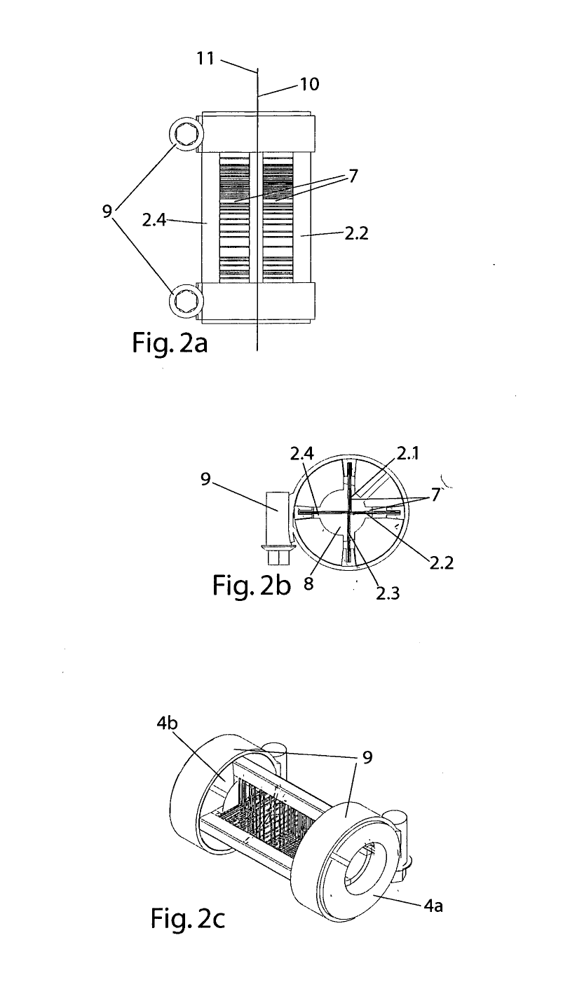

The FIGS. 2a-2c show a second embodiment in side view, top view, and perspective view. This second embodiment does not use one but several brushes 1.2, 2.2, . . . shaped as longitudinal brushes that are primarily located in a longitudinal direction, the running direction 10 or the cable 12.

FIGS. 4a and 4b show such a straight longitudinal brush wherein no bristles 7 protrude from the bristle holder 6 in the axial end areas; however, this is, depending on the design of the cable swiper, not mandatory. Also continuous bristles 7, reaching to the ends of the bristles holder 6, are possible, either bristles evenly axially distributed over bristle holder 6 or distributed differently, also with different materials along its longitudinal extension.

Normally bristles 7 will be evenly distributed and made from the same material.

As FIG. 2b shows in the top view, bristles 7 protrude radially towards the inside from the radially external bristle holders 6 and touch cable 11, not shown in the FIGS. 2, which they are supposed to clean at its outer circumference with their free ends.

FIG. 2b shows, at the upper and lower ends, the longitudinal brushes 2.1, 2.2 with their bristle holder 6 are located in the respective receiving slots 13 of the holders 4a, b which are round at their outer circumference, but slotted and therefore C-shaped, wherein the bristles 7 protrude into the interior cavity 8 of the holders 4a, b, if in this longitudinal area bristles 7 are present in the bristle holder 6 at all.

The holders 4a, b have a circular external circumference around which a hose clamp 9 is placed. Since the bristle holders 6 taper towards the free ends of the bristles in a conical manner, also the receiving slots 13 taper towards the inside in a conical manner so that the bristle holder 6 can be radially inserted there from the outside and can be held in position by the hose clamp 9 and can be pressed in.

In the longitudinal area between holders 4a, b and thereby between the hose clamps 9a, b only the longitudinal bristles 2.1, 2.2 are present and can, therefore, be easily cleaned e.g. manually, or with compressed air.

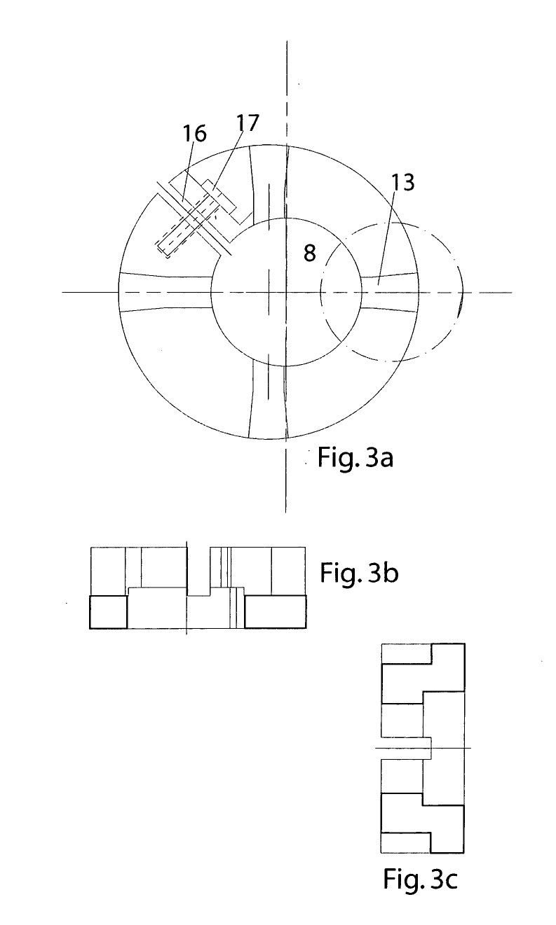

The C-shaped holders 4a, b are somewhat elastic in a radical direction because of adjustment slot 16 reaching toward the middle, as seen in FIG. 3a.

In case the longitudinal brushes 2, different from the illustration of FIG. 4b, have bristles 7 until to the longitudinal ends of the bristle holder 6, thereby with the same actual length of the cable swiper, its swiping length 5 is increased and thereby its cleaning affect is improved.

The central cavity 8 within holders 4a, b is also circular, as well as their external circumference, however, preferably eccentric relative to it, in order to achieve more radial width of the ring of the holder in the area of the adjustment slot 16, so that also a clamping bolt 17, as shown in FIG. 1d/3a can be used.

FIGS. 3a and 3b show a top view and a longitudinal cut view of holder 4b pointing away from the inlet spout 3. Next to adjustment slot 16, which completely reaches through the annular holder in an axial and in a radial manner, the receiving slots 13a, b . . . for the longitudinal brushes 2 completely reach through the holder in radial direction but not in axial direction, so that the holder can be made from one piece. In the top view of FIG. 3a, the conically outward expanding dimensions of the receiving slots 13 can be seen.

To the contrary, the holder 4a, as seen in FIG. 3c, has a wider interior circumference on the axial side, opposed to receiving slots 13, sized for placement onto the exterior circumference of the cable inlet bushing 13.

1. A cable swiper for cleaning a cable passing through in a linear manner, said swiper comprising:
at least one swiper brush having bristles touch an exterior circumference of the cable with its free ends, and which are held in one bristle holder each, with its other ends;
a holding device for fixating the at least one swiper brush at another component associated with a cable outlet bushing; and
the ends of the at least one swiper brush are received between separate holders.

2. A cable swiper according to claim 1 wherein in the area beyond the bristle holders said at least one swiper brush is freely accessible, radially from the outside.

3. A cable swiper according to claim 1 wherein said holding device includes a radially compressing element.

4. A cable swiper according to claim 3 wherein said compressing element is a hose clamp that covers one of said bristle holders as well as the cable inlet bushing, axially abutting to each other, in an axial direction, at least partially.

5. A cable swiper according to claim 1 wherein said at least one swiper brush is a spiral brush whose bristle holder winds around a pass-through direction in a helical manner and whose bristles are pointing radially inward towards a longitudinal axis of the helix, whose central cavity has a smaller diameter then the exterior diameter of the cable.

6. A cable swiper according to claim 5 wherein the windings of the helical bristle holder have a distance relative to each other in longitudinal direction which is larger than the diameter of the cable or of the helical bristle holder, and can be elastically deformed in a longitudinal direction.

7. A cable swiper according to claim 1 wherein the bristle holder is internally stable in an area between the holders in a sideways direction.

8. A cable swiper according to claim 1 wherein said at least one swiper brush are several longitudinal brushes located spaced over a circumference of the cable whose ends are each held in a C-shaped holder.

9. A cable swiper according to claim 8 wherein the longitudinal brushes are straight longitudinal brushes and located in parallel to a running direction of the cable with bristles pointing towards the cable.

10. A cable swiper according to claim 8 wherein the longitudinal brushes have the shape of a helix section with an angular coverage of less than 360°, divided by the number of longitudinal brushes located along the circumference of the cable.

11. A cable swiper according to claim 8 wherein the holders are provided as radially compressible, slotted, C-shaped rings with receiving slots, axially open to one side, radially reaching through the ring, wherein the longitudinal brushes and the bristle holders are radially insertable from outside and/or adjustable.

12. A cable swiper according to claim 11 wherein the receiving slots have a section, conically tapered toward the middle of the rings, and the bristle holders have a cross section tapered toward a bristle exit side.

13. A cable swiper according to claim 8 wherein each holder is surrounded by a hose clamp, which holds the ends of the longitudinal brush in the slots and which can reduce the diameter of the ring shaped holders.

14. A cable swiper according to claim 8 wherein a central cavity for passing the cable through is eccentrically located in the holder and the longitudinal brushes have a different radially protruding length that the central cavity for passing the cable through is centrally located between the brushes, relative to the external circumference of the holder.

15. A cable swiper for cleaning a cable passing through in a linear manner, said swiper comprising:
at least one swiper brush with bristles that touch an outer circumference of the cable with its free ends;
a holding device for mounting the at least one swiper brush to a cable outlet bushing; and
the least one swiper brush extends along a whole swiping length and is stable in itself.

16. A process for assembling a cable swiper having at least one swiper brush, having holders at each end, extend over a whole swiping length in a longitudinal direction on a continuous cable, the holder can be radially opened and radially pushed onto the cable and the brushes are provided as longitudinal brushes, substantially extending in a longitudinal direction, and insertable from the outside with their ends into respective grooves of the axially spaced holders and fixated therein.

17. A process according to claim 16 wherein the fixation is performed by wrapping a hose clamp around and tightening it.

18. A process according to claim 17 wherein the hose clamp adjacent to the cable outlet spout is located in a manner, so that it partially covers the cable outlet spout in an axial direction.
